(19) United States
(12) Patent Application Publication
(10) Pub. No.: US 2021/0104772 A1
(43) Pub. Date: Apr. 8, 2021

(54) DEEP EUTECTIC SOLVENT BASED ELECTROLYTES AND RELATED ELECTROCHEMICAL DEVICE

(71) Applicant: Phased Technologies, Inc., Oneonta, NY (US)

(72) Inventor: Javier Alvare, Sandy, UT (US)

(21) Appl. No.: 17/061,868

(22) Filed: Oct. 2, 2020

Related U.S. Application Data
(60) Provisional application No. 62/909,431, filed on Oct. 2, 2019.
(60) Provisional application No. 62/909,428, filed on Oct. 2, 2019.

(51) Int. Cl. H01M 10/056

(52) U.S. Cl. CPC H01M 10/056; H01M 2300/0011

(57) ABSTRACT

Electrolytes including deep eutectic solvents (DES) are provided. In one example, DES has a formula Cat⁺X⁻.zY, where Cat⁺X⁻ is a salt including a cation Cat⁺ and an anion X⁻ having a hydrogen bond acceptor (HBA) component, Y is a molecule having a hydrogen bond donor (HBD) component that interacts with the HBA component of the anion X⁻, and z is a molar ratio of the HBD component of the molecule Y to the HBA component of the anion X⁻. The DES based electrolytes of the present disclosure have low volatility, non-flammability, wide electrochemical voltage window, and high ionic conductivity, and may be used in electrochemical devices including electrochemical energy storage devices.

### BACKGROUND

The present disclosure relates generally to deep eutectic solvent (DES) based electrolytes and related devices, and more particularly, to deep eutectic solvent (DES) based electrolytes and related electrochemical devices such as electrochemical energy storage devices.

Most electrochemical devices such as primary and secondary batteries, redox flow batteries, supercapacitors, electrolyzers, fuel cells, and others contain liquid electrolytes. In many instances, these liquid electrolytes include mixtures of two or several organic flammable solvents with one or more salt supporting electrolytes. U.S. Pat. No. 5,525,443 discloses a non-aqueous liquid electrolyte for a secondary battery composed of a complex mixture of a lithium salt mixed with a cyclic ester selected from ethylene carbonate, propylene carbonate, and butylene carbonate; or a chain ester selected from diethyl carbonate, dimethyl carbonate, ethyl formate, methyl formate, dimethyl sulfoxide, and others. One of the main drawbacks of these types of electrolytes relates to safety and the limited temperature range of operation. These liquid electrolyte mixtures have low flash points and may form flammable gas mixtures at even room temperature. A serious fire incident may occur if electrolyte vapors are generated and ignited due to overheating from battery self-discharge, over-charge, over-discharge, or by an electrical shorting. Another issue with conventional electrolytes is the combined effect of the presence of small amounts of water and high operating temperature (>40° C.), which may lead to the undesirable decomposition of the lithium salts in solution.

U.S. Pat. No. 8,715,866 discloses an ionic liquid (IL)-based electrolyte including a mixture of a heterocyclic compound and a lithium salt, where the heterocyclic compound is imidazole, pyrazole, triazole, N-ethylimidazole, pyrimidine, 4-isopropylimidazole, 4-methylimidazole, or ethoxypyridine. This type of electrolyte mixture may offer advantages such as chemical, thermal and electrochemical stabilities, and non-flammability, thereby addressing problems associated with ignition, evaporation, and side reactions of the liquid electrolyte mixture. However, such electrolyte mixtures have high viscosity and low ionic conductivity that may translate into a large overpotential and loss of electrochemical performance. In addition, ionic liquid-based liquid electrolytes are known to be chemically sensitive to small traces of water and costly to manufacture and purify.

The market is still in need of a liquid electrolyte suitable for electrochemical devices while addressing the problems faced by the conventional liquid electrolytes.

### SUMMARY

A first aspect of the present disclosure provides an electrolyte comprising: a deep eutectic solvent having a formula Cat⁺X⁻.zY, wherein Cat⁺X⁻ is a salt in which Cat⁺ is a cation selected from a group consisting of a quaternary ammonium cation, a sulfonium cation, and a phosphonium cation; X⁻ is an anion having a hydrogen bond acceptor (HBA) component; Y is a molecule having a hydrogen bond donor (HBD) component that interacts with the hydrogen bond acceptor (HBA) component of the anion X⁻; and z is a molar ratio of the HBD component of the molecule Y to the HBA component of the anion X⁻, wherein the deep eutectic solvent imparts a property of an ionic conductivity in the electrolyte in a range of about 5 mS/cm to about 35 mS/cm when measured at room temperature.

A second aspect of the present disclosure provides an electrolyte comprising: a deep eutectic solvent having a formula Cat⁺X⁻.zY, wherein Cat⁺X⁻ is a salt including a cation Cat⁺ and an anion X⁻ having a hydrogen bond acceptor (HBA) component, wherein the Cat⁺X⁻ salt is selected from the group consisting of a quaternary ammonium salt, a sulfonium salt, a phosphonium salt, an alkali metal salt, and an alkali-earth metal salt; Y is a molecule having a hydrogen bond donor (HBD) component that interacts with the hydrogen bond acceptor (HBA) component of the anion X⁻, wherein Y is a formamide (FA), 1,3-propanediol (PNDO), methylformamide (MFA), ethylene glycol (EG), or any combination thereof; and z is a molar ratio of the HBD component of the molecule Y to the HBA component of the anion X⁻.

A third aspect of the present disclosure provides an electrochemical device comprising: a cathode, an anode, and an electrolyte including: a deep eutectic solvent having a formula Cat⁺X⁻.zY, wherein Cat⁺X⁻ is a salt in which Cat⁺ is a cation selected from a group consisting of a quaternary ammonium cation, a sulfonium cation, and a phosphonium cation; X⁻ is an anion having a hydrogen bond acceptor (HBA) component; Y is a molecule having a hydrogen bond donor (HBD) component that interacts with the hydrogen bond acceptor (HBA) component of the anion X⁻; and z is a molar ratio of the HBD component of the molecule Y to the HBA component of the anion X⁻, wherein the deep eutectic solvent imparts a property of an ionic conductivity in the electrolyte in a range of about 5 mS/cm to about 35 mS/cm when measured at room temperature.

The illustrative aspects of the present disclosure are designed to solve the problems herein described and/or other problems not discussed.

### BRIEF DESCRIPTION OF THE DRAWINGS

FIG. 1 show plots of ionic conductivity (mS/cm) versus temperature (° C.) for five DES-based electrolytes described in Example 1, in accordance with embodiments of the present disclosure;

FIG. 2 shows plots of ionic conductivity (mS/cm) versus temperature (° C.) for two DES-based electrolytes described in Example 2, in accordance with embodiments of the present disclosure;

FIG. 3 shows plots of current density (mA/cm²) versus voltage of two DES-based electrolytes described in Example 3, in accordance with embodiments of the present disclosure; and

FIG. 4 shows plots of current density (mA/cm²) versus voltage obtained at a sweep rate of 100 mV/s (100 cycles) for a supercapacitor test cell with activated carbon electrodes and a DES-based electrolyte (TRMACl-MFA) described in Example 5, in which cycles #1, #10, #20, #50, #80, and #100 have been plotted, in accordance with embodiments of the present disclosure.

It is noted that the drawings are intended to depict only typical aspects of the disclosure, and therefore should not be considered as limiting the scope of the disclosure.

### DETAILED DESCRIPTION

The present disclosure provides a novel type of deep eutectic solvent (DES) based electrolytes and related electrochemical devices. The term “DES(s),” “DES sample(s),” “DES based electrolyte(s),” “eutectic solvent mixture(s),” “deep eutectic solvent(s),” “deep eutectic solvent mixture(s),” and “liquid electrolyte(s)” may be used interchangeably throughout the present disclosure. DES of the present disclosure may be formed from an eutectic mixture of Lewis or Bronsted acids and Lewis bases, which may contain a variety of anionic and/or cationic species. DES of the present disclosure may be obtained by complexation, or by mixing, in a specific molar ratio, a salt Cat⁺X⁻ and a molecule Y. The salt Cat⁺X⁻ may include a cation Cat⁺ and an anion X⁻, where the anion X⁻ has a hydrogen bond acceptor (HBA) component. The molecule Y may include a hydrogen bond donor (HBD) component that interacts with the hydrogen bond acceptor (HBA) component of the anion X⁻, to provide a eutectic solvent mixture. Without being bound by theory, it is hypothesized that a charge delocalization that occurs through hydrogen bonding(s) between the HBA and the HBD components may be responsible for a decrease in the melting point of the eutectic solvent mixture relative to the melting points of each individual components such as the salt Cat⁺X⁻ and the molecule Y. Though DES may share certain properties with conventional ion liquids (IL) such as low flammability, they may also offer tremendous advantages over IL, for example their high ionic conductivity, low cost, straightforward preparation, chemical inertness with water, and biodegradability, among others. DES samples of the present disclosure may be synthesized by mixing two or more components of the deep eutectic solvent under moderate heating, for example, at a temperature selected such that a homogenous liquid is formed. The readily available and relatively inexpensive raw materials, combined with the simple synthesis, make DES exceedingly cost efficient as compared to conventional IL.

According to an aspect of the present disclosure, an electrolyte including a deep eutectic solvent having a formula Cat⁺X⁻.zY is provided, where Cat⁺X⁻ is a salt, and where Cat⁺ is a cation and an anion X⁻ having a hydrogen bond acceptor (HBA) component, Y is a molecule having a hydrogen bond donor (HBD) component that forms hydrogen bonding(s) with the HBA component of the anion X⁻, and z is a number of molecules of Y (acting as a hydrogen bond donor) per molecules of X⁻ (acting as a hydrogen bond acceptor). In certain embodiments, z is a molar ratio of the HBD component of Y to the HBA component of X⁻.

In certain embodiments, the deep eutectic solvent imparts a property of an ionic conductivity in the electrolyte in a range of about 5 mS/cm to about 35 mS/cm, when measured at room temperature (i.e., about 20-25° C.) or ambient temperature, for example, about 5, 10, 15, 20, 25, 30, 35 mS/cm, including any ranges between the foregoing numeric temperature values. In certain embodiments, the ionic conductivity is in a range of about 10 mS/cm to about 35 mS/cm, or in a range of about 10 mS/cm to about 30 mS/cm, or in a range of about 10 mS/cm to about 25 mS/cm, or in a range of about 10 mS/cm to about 20 mS/cm, when measured at room temperature (i.e., about 20-25° C.) or ambient temperature. In certain embodiments, the molar ratio of the HBD and the HBA components may be in a range of about 3:1 to about 10:1. For example, the molar ratio of HBD and HBA components may be about 3:1, 4:1, 5:1, 6:1, 7:1, 8:1, 9:1, or 10:1, including any ranges between the foregoing numeric molar ratio values.

In certain embodiments, the cation Cat⁺ includes, but is not limited to, a quaternary ammonium cation, a phosphonium cation, a sulfonium cation, an alkali metal cation, or an alkali-earth metal cation. In non-limiting examples, the cation Cat⁺ may include, but is not limited to, a trimethylammonium cation, a choline cation, an ammonium cation, a tetramethylammonium cation, an ethylammonium cation, or a methylammonium cation.

In certain embodiments, Cat⁺ may be an alkylammonium cation having a formula of R₁R₂R₃R₄N⁺ where R₁, R₂, R₃, and R₄ is each independently chosen from a hydrogen atom, an alkyl, a substituted alkyl, or a cycloalkyl. As referred to herein, alkyl is intended to include linear, branched, or cyclic hydrocarbon structures and combinations thereof. Lower alkyl refers to alkyl groups of from 1 to 4 carbon atoms. Non-limiting examples of lower alkyl groups include methyl, ethyl, propyl, isopropyl, butyl, s- and t-butyl. Preferred alkyl groups are those of C₂₀ or below. As referred to herein, cycloalkyl is a subset of alkyl and includes cyclic hydrocarbon groups of from 3 to 8 carbon atoms. Non-limiting examples of cycloalkyl include c-propyl, c-butyl, c-pentyl, and norbornyl. Substituted alkyl or substituted cycloalkyl refer respectively to alkyl or cycloalkyl where up to three H atoms in each residue are replaced with halogen, haloalkyl, hydroxy, lower alkoxy, carboxy, carboalkoxy, carboxamido, cyano, carbonyl, nitro, primary amino, secondary amino, alkylthio, sulfoxide, sulfone, acylamino, amidino, phenyl, benzyl, heteroaryl, phenoxy, benzyloxy, heteroaryloxy, or substituted phenyl, benzyl, heteroaryl, phenoxy, benzyloxy, or heteroaryloxy.

In certain embodiments, the anion X⁻ includes, but is not limited to, a halide anion, NO₃⁻, N(CN)₂⁻, BF₄⁻, ClO₄⁻, PF₆⁻, AsF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, or (CF₃CF₂SO₂)₂N⁻. The halide anion may include F⁻, Cl⁻, Br⁻, or I⁻. In certain embodiments, the anion X⁻ is selected from the group consisting of F⁻, Cl⁻, Br⁻, I⁻, and NO₃⁻.

In certain embodiments, the Y molecule includes, but is not limited to, an amide, an amine, an alcohol, an aldehyde, water, a carboxylic acid, or any combination thereof. Non-limiting examples of Y may include formamide (FA), 1,3-propanediol (PNDO), methylformamide (MFA), ethylene glycol (EG), or any combination thereof.

In certain embodiments, Cat⁺X⁻ may be a salt that includes, but is not limited to, a quaternary ammonium salt, a sulfonium salt, a phosphonium salt, an alkali metal salt, or an alkali-earth metal salt. In some embodiments, Cat⁺X⁻ may be a quaternary ammonium salt. Non-limiting examples of Cat⁺X⁻ salt may include tetramethylammonium chloride (TMACl), choline chloride (ChCl), trimethylammonium chloride (TRMACl), ethylammonium chloride (EACl), or methylammonium chloride (MACl), ammonium fluoride (AFl), tetramethylammonium nitrate (TMANO₃), or choline nitrate (ChNO₃), or any combination thereof.

In some embodiments, Cat⁺X⁻ may be a quaternary ammonium salt, and Y may be formamide (FA), 1,3-propanediol (PNDO), methylformamide (MFA), ethylene glycol (EG), or any combination thereof.

In certain embodiments, z may be in a range of 1 to 20. For example, z may be about 1, 2, 3, 4, 5, 6, 7, 8, 9, 10, 15, or 20, including any ranges between the foregoing numeric values.

The electrolytes of the present disclosure may further include one or more supporting electrolyte(s) that impart a property in the electrolyte of increased ionic conductivity in comparison to a reference electrolyte that does not include the supporting electrolyte(s). In certain embodiments, the supporting electrolyte(s) may include one or more active ionic species depending on the application. In a non-limiting example, for a lithium ion battery application, supporting electrolyte(s) containing lithium ions including, but not limited to, LiPF₆, LiTFSI, or LiCl may be added. In other non-limiting examples, the supporting electrolyte(s) may include one or more additives that impart a property in the electrolyte of a reduced viscosity in comparison to a reference electrolyte that does not include the supporting electrolyte(s). Various additives may be used, depending on the application. Examples of additives may include, but are not limited to, linear alkyl carbonates such as diethylcarbonate (DEC), dimethyl carbonate (DMC), nitriles such as acetonitrile, or propionitrile, or any combination thereof.

The deep eutectic solvent and DES-based electrolytes of the present disclosure offer advantages including, but are not limited to, the following benefits.

1. Safe, non-flammable, low volatility, and low toxicity: The melting points of many DES of the present disclosure are extremely low at their eutectic compositions, and as a result, their vapor pressures are orders of magnitude smaller than traditional carbonate-based electrolytes at temperatures where the latter would form dangerous flammable mixtures. In certain embodiments, the DES s are extremely chemically stable even at high temperatures.

2. Inexpensive raw material components and simple synthesis: The raw starting materials for preparing DES samples of the present disclosure may include chemicals that may be produced from earth abundant materials in large quantities, and therefore provide significant cost benefits for large scale production. Their production may involve mixing of two or more components, generally with moderate heating. Also unlike many conventional ILs, the DESs of the present disclosure may be inert to the presence of water, hence costly purification steps are not required during manufacturing.

3. High ionic conductivity: A clear advantage of DESs of the present disclosure over conventional electrolytes is that the DESs are composed of ionic species and their conductivity values are higher than conventional organic solvent electrolytes without a need for the presence of any supporting electrolytes in the electrolyte solution. Hence, the need to have high amounts of costly salts in solution (e.g., battery grade lithium salts such as LiTFS) is not required to maximize the electrolyte conductivity. In some embodiments of the present disclosure, it has been demonstrated that DES made from quaternary ammonium salts mixed with ethylene glycol or methyl formamide having hydrogen bond donor components, have high temperature conductivities 2-3 times higher than conventional carbonate-based electrolytes. DES may match the conductivity of carbonate-based electrolytes at low temperatures, while offering a tremendous advantage at higher temperatures, for example, certain DES samples may have conductivity values close to 50 mS/cm at 40° C. In addition, it has been shown that embodiments of DESs based electrolytes of the present disclosure have conductivity values an order of magnitude higher than the conventional ILs, such as the ones based on imidazolium type structures.

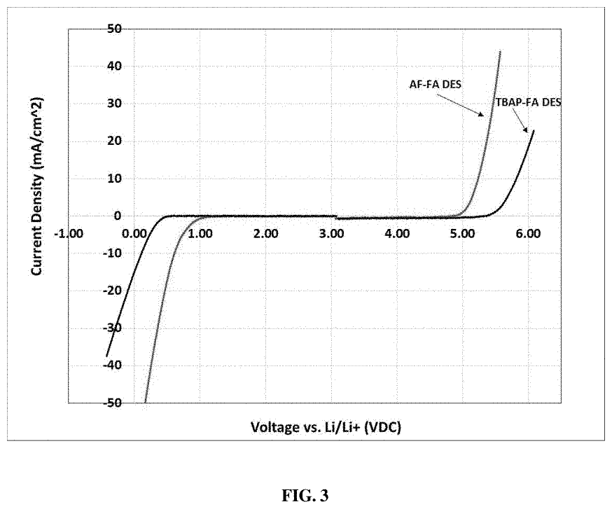

4. Wide electrochemical voltage window: Without being bound by theory, it is believed that the high resistance to reduction of the protons may be associated with strong hydrogen bonding ability between the protons of the hydrogen bond donor (HBD) and hydrogen bond acceptor (HBA) components. FIG. 3 shows the cyclic voltammograms of two DES composed of ammonium fluoride (AFl) with formamide (FA), and tetrabutylammonium perchlorate (TBAP) with formamide (FA), respectively. The experimental data shows that DES have electrochemical voltage windows large enough to be suitable for many electrochemical devices including, but are not limited to, energy storage device such as lithium ion batteries.

5. Low melting points and high decomposition temperatures: DES may include mixtures of two or more components (e.g., a DES of formula Cat⁺X⁻.zY may include a salt Cat⁺X⁻ and a molecule Y, where z is a predefined molar ratio of HBD component of Y to the HBA component of X⁻, such that the melting point of the resulting DES fluid is the lowest possible (eutectic composition). Therefore, the melting point of the formed DES is significantly lower than that of their initial components (e.g., salt Cat⁺X⁻ and molecule Y). For example, the DES with formula ChCl.₂.2EG is formed by a mixture of choline chloride (ChCl, melting point (MP)=302° C.) and ethylene glycol (EG, MP=−13° C.) on a 1:2 molar ratio, and the DES formed has a melting point of about −66° C. At the same time, DES may have very high thermal decomposition temperatures. For example, various choline-based DES may decompose in a temperature range of about 269-280° C., which is significantly higher than the thermal decomposition temperatures of each respective individual component.

6. High solubility of ionic salts: DES may be highly polar solvents and therefore have the ability to solvate and dissolve ionic species. The polarity of DES having a formula Cat⁺X⁻.zY may be fine-tuned to a particular salt of interest by selecting appropriate HBD component of molecule Y. The present disclosure demonstrates that DES made with quaternary ammonium cation as Cat⁺ and ethylene glycol as the HBD component can dissolve large quantities of the typical lithium salts used in Li-ion batteries such as lithium hexafluoro phosphate (LiPF₆), lithium bis(fluorosulphonyl)imide (LiTFSI), lithium perchlorate (LiClO₄), and others.

7. Large tuneability potential for task-specific applications: The present disclosure describes various combinations of the HBD and the HBA component, which allows the properties of DESs to be tailored for task-specific applications. The DES samples of the current disclosure may find uses in various electrochemical devices including, but not limited to, a primary battery, a secondary battery, an electrochemical supercapacitor, a redox-flow battery, a fuel cell, an electrolyzer, or any combination thereof. The secondary batteries may include, but are not limited to, lithium-ion batteries, sodium-ion batteries, lithium metal batteries, sodium metal batteries, magnesium-metal batteries, potassium-ion batteries, lithium-sulfur batteries, sodium-sulfur batteries, lithium-air batteries, sodium-air batteries, zinc-air batteries, nickel/metal hydride batteries, nickel-cadmium batteries, nickel-zinc batteries, polysulfide bromide batteries, silicon-air batteries, silver-zinc batteries, silver calcium batteries, zinc ion batteries, zinc chloride batteries, nickel hydrogen batteries, nickel-iron batteries, nickel metal hydride batteries, or any combination thereof.

In an example embodiment, an electrochemical device including a cathode, an anode, and the DES based electrolyte of the present disclosure is provided. In certain embodiments, the electrochemical device may include a cathode, an anode, a separator, an anode current collector, a cathode current collector, and the DES based electrolyte. In further embodiments, the device may be an electrochemical supercapacitor. In some embodiments, the electrode material may include, but is not limited to, activated carbon, carbon nanotubes, 2-D transition metal carbides or nitrides, graphene, layered titanate nanotubes, ruthenium oxide, iridium oxide, titanium oxide, nickel oxide, manganese oxide, polyaniline conducting polymers, or any combination thereof.

Hereinafter, various examples of the present invention will be described in detail for the sake of explanation. However, the examples of the present disclosure may be modified in various ways, and they should not be interpreted as limiting the scope of the invention.

### EXPERIMENTAL

### Preparation of DES Samples

DES samples of the present disclosure may be prepared by mixing a salt having a formula of Cat⁺X⁻ where Cat⁺ is a cation, X⁻ is an anion having a hydrogen bond acceptor (HBA) component, with a molecule Y having a hydrogen bond donor (HBD) component that interacts with the anion X⁻, in a molar ratio of HBD:HBA to form a respective DES-based electrolyte sample with a formula Cat⁺X⁻.zY, where z is a molar ratio of the HBD component of Y to the HBA component of X⁻. In the non-limiting examples listed in the experimental section herein, DES samples were prepared according to the general method described above. For example, to prepare the samples having a formula Cat⁺X⁻.zY in Table 1 below, the corresponding Cat⁺X⁻ salt and molecule Y were mixed with a predefined molar ratio of HBD:HBA in a container (e.g., a 100 mL glass beaker), and heated at a temperature (e.g., 120° C.) such that a homogenous liquid is formed. The reaction was carried out inside an inert environment (e.g., a dry glove box under an Argon (Ar) gas atmosphere).

### Ionic Conductivity

### Example 1

DES samples were prepared according to the method described above. The ionic conductivity of the prepared samples was measured using a Metler-Toledo conductivity meter instrument. The viscosity of the prepared samples was measured using a viscometer (e.g., Brookfield CAP 2000+, AMETEK Brookfield, Middleboro, Mass.). It is appreciated that any currently known or later developed techniques/instruments suitable for measuring ionic conductivity and/or viscosity may be used.

Table 1 lists experimental results for the five DES samples of Example 1, including measured ionic conductivity at 25° C. and measured viscosity at 25° C. The DES has a formula of Cat⁺X⁻.zY as detailed in Table 1:

TABLE 1

| | | | Molar | | Ionic | |
|---|---|---|---|---|---|---|
| | | | Ratio of | | Conductivity | Viscosity |
| DES Sample ID | Cat⁺X⁻ | Y | HBD:HBA | z | (mS/cm) | (centipoises) |
| TRMACl-FA-0026 | TRMACl | FA | 6:1 | 6 | 31.7 | 7 |
| ChCl-FA-0023 | ChCl | FA | 4:1 | 4 | 13.0 | 10.6 |
| AF-EG-0027 | AF | EG | 6:1 | 6 | 5.86 | 41 |
| TMANO₃-FA-0030 | TMANO₃ | FA | 10:1 | 10 | 21.1 | |
| ChNO₃-EG-0031 | ChNO₃ | EG | 3:1 | 3 | 11.5 | 37 |

Codes used for examples in Table 1: TRMACl: trimethylammonium chloride; ChCl: choline chloride; AF: ammonium fluoride; TMANO₃: tetramethylammonium nitrate; ChNO₃: choline nitrate; FA: formamide; EG: ethylene glycol.

The molar ratio of HBD:HBA refers to the molar ratio of the hydrogen bond donor (HBD) component of Y molecule to the hydrogen bond acceptor (HBA) component of anion X⁻.

As shown in Table 1, the DES electrolyte samples have significantly higher ionic conductivity, for example, an order of magnitude higher than conventional electrolyte samples such as conventional ionic liquids based on imidazolium type structures. For example, a conventional ionic liquid based electrolyte consisting of 1-Butyl-1-methylpyrrolidinium bis(trifluoromethylsulfonyl)imide (PYR14-TFSI) with 0.4 M of lithium bis(trifluoromethanesulfonyl)imide (LiTFSI, as supporting lithium salt) has a conductivity of less than 1 mS/cm at 20° C.

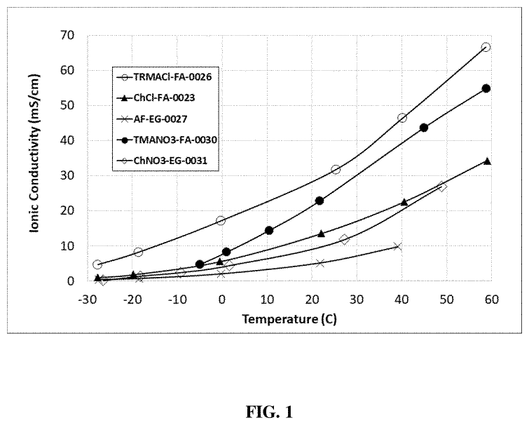

As illustrated in FIG. 1, which shows plots of ionic conductivity (mS/cm) versus temperature (° C.) for five DES electrolyte samples of Example 1, DES samples of the present disclosure present a new class of electrolytes with unique structures and offer tremendous advantages, with high ionic conductivity obtained at room temperature and higher, compared to the conventional electrolytes. For example, ionic conductivity value of about 47 mS/cm at 40° C. may be achieved with the DES of the present disclosure, which is significantly higher than the reported or known conventional electrolytes, and overcoming the challenges associated with conventional electrolytes. In certain embodiments, the ionic conductivity of the electrolyte is in a range of about 5 mS/cm to about 35 mS/cm, when measured at room temperature (about 20-25° C.). These superior results of high ionic conductivity provide benefits and advantages for applying DES based electrolytes in applications involving electrochemical devices such as energy storage devices.

### Example 2

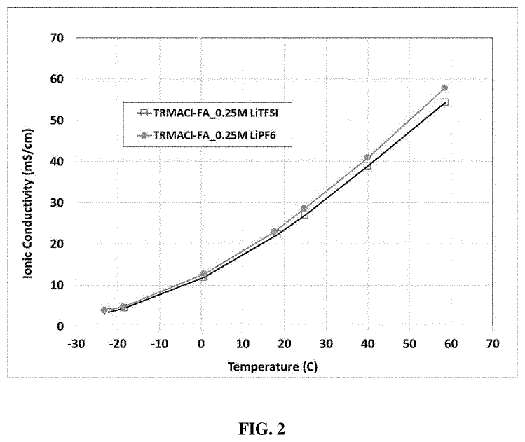

DES samples suitable for lithium (Li)-ion battery application were prepared, using the method described in the present disclosure and similarly applied for Example 1. More specifically, two DES based electrolytes containing lithium salts (sample #1 TRMACl-FA_0.25 M LiTFSI and sample #2 TRMACl-FA_0.25 M LiPF₆) were prepared by mixing trimethylammonium chloride (TRMACl) and formamide (FA), in a molar ratio of HBD:HBA of 6:1 with 0.25 molar of lithium bis(trifluoromethanesulfonyl)imide (LiTFSI), and 0.25 molar of lithium hexafluoro phosphate (LiPF₆), respectively. FIG. 2 shows the plots of ionic conductivity vs. temperature (° C.) of each DES sample of Example 2 at which the ionic conductivity was measured.

### Electrochemical Voltage Window

### Example 3

Preparation of representative DES samples and measurement of their respective electrochemical windows are provided. Two DES samples were prepared by mixing ammonium fluoride (AF) with formamide (FA), and tetrabutylammonium perchlorate (TBAP) with formamide (FA), respectively, to provide corresponding samples AF-FA DES and TBAP-FA DES, as shown in Table 2.

Table 2 also shows the electrochemical voltage window for the samples of AF-FA DES and TBAP-FA DES in volts versus a Li/Li⁺ reference electrode. The electrochemical voltage window was measured by cyclic voltammetry technique, using a glassy carbon as a working electrode and an Ag/AgNO₃ reference electrode. The measured voltage window was then converted to a voltage window with respect to the Li/Li⁺ reference electrode, and was reported in Table 2 and plotted in FIG. 3.

It is appreciated that any currently known or later developed techniques/instruments suitable for measuring electrochemical voltage window may be used.

TABLE 2

| | | | | Electrochemical |
|---|---|---|---|---|
| DES Sample ID | Cat⁺X⁻ | Y | z | voltage Window (V) |
| AF-FA DES | AF | FA | 6 | 0.9-5.0 |
| TBAP-FA DES | TBAP | FA | 6 | 0.5-5.5 |

Codes used for examples in Table 2: AF: ammonium fluoride; TBAP: tetrabutylammonium perchlorate; FA: formamide.

FIG. 3 shows cyclic voltammograms of the two DES samples shown in Table 2 (AF-FA DES and TBAP-FA DES). No lithium salts are present in these two DES samples. The cyclic voltammogram was obtained using a glassy carbon working electrode, a platinum wire counter electrode, and the silver/silver nitrate reference electrode at a sweep rate of 100 mV/s. The current density data in the voltammogram is plotted against voltage vs. Li/Li⁺ reference electrode discussed earlier with respect to Table 2. The experimental data of FIG. 3 demonstrates that DES samples of the present disclosure have electrochemical voltage windows large enough to be suitable for many electrochemical energy storage devices including, but not limited to, lithium ion batteries. Without being bound by theory, it is hypothesized that the strong hydrogen bonding ability between the protons of the hydrogen bond donor (HBD) and the hydrogen bond acceptor component (HBA) of the DES of the present disclosure contributes to the high resistance to reduction of the protons.

### Melting Points

### Example 4

Preparation of non-limiting examples of DES samples and determination of their melting points are provided. One of the unique properties of DES samples of the present disclosure is their low melting temperatures or melting points, which make them very attractive for low temperature electrochemical applications. A number of representative DES samples were prepared including Cat⁺X⁻ salt having a HBA component and Y molecule having a HBD component as shown in Table 3, using a similar method as described with respect to samples in Example 1. The melting points of the prepared DES samples were measured using standard techniques such as Differential Scanning calorimeter (DSC), with the results summarized in Table 3 below. It is appreciated that any currently known or later developed techniques/instruments suitable for measuring melting points may be used.

TABLE 3

| | | | Molar Ratio | | Melting |
|---|---|---|---|---|---|
| | | | of | | Temperature |
| DES Sample ID | Cat⁺X⁻ | Y | HBD:HBA | z | (° C.) |
| TMACl-EG | TMACl | EG | 3:1 | 3 | −40 |
| ChCl-EG | ChCl | EG | 3:1 | 3 | <−100 |
| ChCl-PNDO | ChCl | PNDO | 3:1 | 3 | <−100 |
| TRMACl-MFA | TRMACl | MFA | 8:1 | 8 | −42 |
| EACl-EG | EACl | EG | 4:1 | 4 | <−100 |
| LiNO₃-EG | LiNO₃ | EG | 4:1 | 4 | <−100 |
| ChCl-FA | ChCl | FA | 4:1 | 4 | −15 |
| TRMACl-FA | TRMACl | FA | 4:1 | 4 | −63 |
| MACl-FA | MACl | FA | 4:1 | 4 | −52 |

Codes used for examples in Table 3: TMACl: tetramethylammonium chloride; ChCl: choline chloride; TRMACl: trimethylammonium chloride; EACl: ethylammonium chloride; LiNO₃: lithium nitrate; MACl: methylammonium chloride; EG: ethylene glycol; PNDO: 1,3-propanediol; MFA: methylformamide; FA: formamide.

The melting points of DES at their eutectic compositions may be extremely low, which is advantageous because of the low melting points. The vapor pressures of the DES may be orders of magnitude smaller than reported vapor pressures of conventional carbonate-based electrolytes at temperatures where the carbonate-based electrolytes would form dangerous flammable mixtures.

### Supercapacitors Containing DES Based Electrolytes

### Example 5

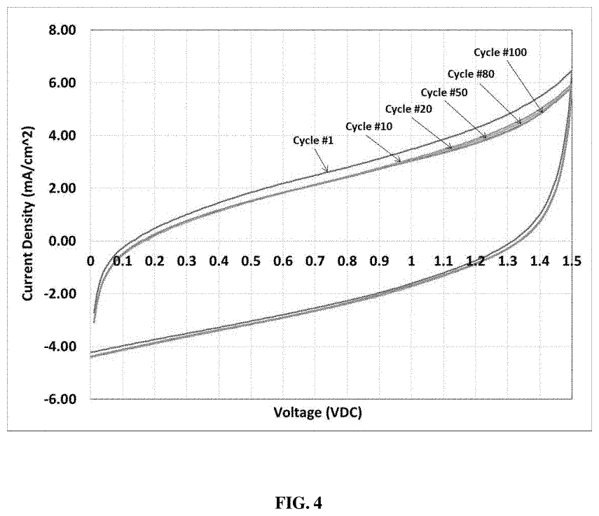

Evaluation of non-limiting examples of supercapacitor test cells containing DES based electrolytes is provided. In certain embodiments, a symmetric supercapacitor test cell was assembled with activated carbon electrodes and with trimethylammonium chloride-methylformamide (TRMACl-MFA, sample details listed in Table 3) as a DES based electrolyte. While the symmetric supercapacitor test cell is tested here for illustration purposes, in some embodiments, the supercapacitor test cell may not be symmetric. A cyclic voltammetry (CV) experiment was carried out, where the voltage was cycled linearly from 0 V to 1.5 V and then back from 1.5 V to 0 V at a rate of 100 mV/s and at room temperature and the respective current was measured. The CV experiment was repeated for 100 cycles. FIG. 4 shows CV plots where current densities (mA/cm2) are plotted against voltage for representative cycles at cycle number #1, #10, #20, #50, #80, and #100. It can be seen that after an initial activation period that lasted for approximately 10 cycles, the supercapacitor test cell using DES electrolyte TRMACl-MFA retained more than 98% of its electrochemical performance as measured by its specific capacitance after 100 cycles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “About” and “approximately,” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to explain the principles of the disclosure and the practical application, and to enable others of ordinary skill in the art to understand the disclosure for various embodiments with various modifications as are suited to the particular use contemplated.

What is claimed is:

1. An electrolyte comprising: a deep eutectic solvent having a formula Cat⁺X⁻.zY, wherein Cat⁺X⁻ is a salt, wherein Cat⁺ is a cation selected from a group consisting of a quaternary ammonium cation, a sulfonium cation, and a phosphonium cation; X⁻ is an anion having a hydrogen bond acceptor (HBA) component; Y is a molecule having a hydrogen bond donor (HBD) component that interacts with the hydrogen bond acceptor (HBA) component of the anion X⁻; and z is a molar ratio of the HBD component of the molecule Y to the HBA component of the anion X⁻, wherein the deep eutectic solvent imparts a property of an ionic conductivity in the electrolyte in a range of about 5 mS/cm to about 35 mS/cm when measured at room temperature.

2. The electrolyte of claim 1, wherein the molar ratio of the HBD to the HBA components is in a range of about 3:1 to about 10:1.

3. The electrolyte of claim 1, wherein the cation Cat⁺ has a formula of R₁R₂R₃R₄N⁺, wherein R₁, R₂, R₃, and R₄ are each independently a hydrogen atom, an alkyl, or a substituted alkyl.

4. The electrolyte of claim 1, wherein the cation Cat⁺ is selected from the group consisting of: tetramethylammonium cation, choline cation, trimethylammonium cation, ethylammonium chloride cation, and methylammonium cation.

5. The electrolyte of claim 1, wherein the anion X⁻ is selected from the group consisting of: F⁻, Cl⁻, Br⁻, I⁻, NO₃⁻, N(CN)₂⁻, BF₄⁻, ClO₄⁻, PF₆⁻, AsF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

6. The electrolyte of claim 1, wherein the anion X⁻ is selected from the group consisting of: F⁻, Cl⁻, Br⁻, I⁻, and NO₃⁻.

7. The electrolyte of claim 1, wherein Y is an amide, an amine, an alcohol, an aldehyde, water, a carboxylic acid, or any combination thereof.

8. The electrolyte of claim 1, wherein Y is formamide (FA), 1,3-propanediol (PNDO), methylformamide (MFA), ethylene glycol (EG), or any combination thereof.

9. The electrolyte of claim 1, wherein Cat⁺X⁻ is a quaternary ammonium salt, and wherein Y is formamide (FA), 1,3-propanediol (PNDO), methylformamide (MFA), ethylene glycol (EG), or any combination thereof.

10. The electrolyte of claim 1, further comprising: a supporting electrolyte that imparts a property of an increased ionic conductivity in the electrolyte in comparison to a reference electrolyte that does not include the supporting electrolyte.

11. The electrolyte of claim 1, further comprising: an active redox species.

12. The electrolyte of claim 1, further comprising: an additive that imparts a property of a reduced viscosity in the electrolyte in comparison to a reference electrolyte that does not include the additive.

13. An electrolyte comprising: a deep eutectic solvent having a formula Cat⁺X⁻.zY, wherein Cat⁺X⁻ is a salt including a cation Cat⁺ and an anion X⁻ having a hydrogen bond acceptor (HBA) component, wherein the Cat⁺X⁻ salt is selected from the group consisting of: a quaternary ammonium salt, a sulfonium salt, a phosphonium salt, an alkali metal salt, and an alkali-earth metal salt; Y is a molecule having a hydrogen bond donor (HBD) component that interacts with the hydrogen bond acceptor (HBA) component of the anion X⁻, wherein Y is a formamide (FA), 1,3-propanediol (PNDO), methylformamide (MFA), ethylene glycol (EG), or any combination thereof; and z is a molar ratio of the HBD component of the molecule Y to the HBA component of the anion X⁻.

14. The electrolyte of claim 13, wherein the deep eutectic solvent imparts a property of an ionic conductivity in the electrolyte in a range of about 5 mS/cm to about 35 mS/cm when measured at room temperature.

15. The electrolyte of claim 13, wherein z is in a range of about 3:1 to about 10:1.

16. The electrolyte of claim 13, wherein the cation Cat⁺ has a formula of R₁R₂R₃R₄N⁺, wherein R₁, R₂, R₃, and R₄ are each independently a hydrogen atom, an alkyl, or a substituted alkyl.

17. The electrolyte of claim 13, wherein the cation Cat⁺ is selected from the group consisting of: tetramethylammonium cation, choline cation, trimethylammonium cation, ethylammonium chloride cation, and methylammonium cation.

18. The electrolyte of claim 13, wherein the cation Cat⁺ is Li⁺.

19. The electrolyte of claim 13, wherein the anion X⁻ is selected from the group consisting of: F⁻, Cl⁻, Br⁻, I⁻, and NO₃⁻.

20. An electrochemical device comprising: a cathode, an anode, a separator, an anode current collector, a cathode current collector, and the electrolyte of claim 1.
